(19) United States
(12) Patent Application Publication
(10) Pub. No.: US 2004/0038738 A1
(43) Pub. Date: Feb. 26, 2004

(54) Electronic game device for simulating real wrestle

(76) Inventor: Guo Pengfei, Hunan Province (CN)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/415,044

(22) PCT Filed: Oct. 23, 2001
(86) PCT No.: PCT/CN01/01494

(30) Foreign Application Priority Data
Oct. 27, 2000 (CN) 00225847.1

(51) Int. Cl. A63F 13/00

(52) U.S. Cl. 463/36

(57) ABSTRACT

An electronic game device for simulating real wrestle which can be connected with a game machine or a computer is provided with a signal input device with a accelerating switch carrying with a portion of a player's body. The signals are transmitted by the radio or cable. The action for imitating real wrestle by a player, such as to kick legs or hit with his fists can control the action of a role in the screen. The device makes games more interesting, and can improve player's body reaction and health.

### FIELD OF THE INVENTION

The present invention relates to an electronic game device for simulating real wrestle.

### DESCRIPTION OF THE PRIOR ARTS

The present devices for playing video game generally includes computer, domestic and professional video game player, and the playing of the wrestle or action-related game is accomplished by using a handle-controlled keyboard, joystick, computer keyboard or remote controlled stick. After long time of playing, the player is susceptible to the fatigue of the eyes and fingers; furthermore, it is less interest and cannot achieve the purpose of keeping fit and physical training.

The present invention has arisen to mitigate and/or obviate the afore-described disadvantages of the conventional electronic game device.

### OBJECTIVE OF THE INVENTION

The primary object of the present invention is to provide an electronic game device for simulating the real wrestle, which will not only accomplish all the kinds of control of the game, but also part of the controls are accomplished by the players simulating the real wrestle.

### TECHNICAL SOLUTION OF THE INVENTION

In accordance with one aspect of the present invention, there is provided with an electronic game device for simulating real wrestle which generally comprises: a housing, which can be the housing of the video game player or the computer, is provided with circuit board.The circuit board comprises power input terminal, signal input and output terminals, and further comprises a signal input device can be worn by the player for radio or cable transmitting signals to the signal input terminal. The signal input device consists of a plurality of accelerating switches. These accelerating switches are positioned on the wrists, feet or other parts of the player with different angles. In case that the player waves his fists and moves feet according to the video display, due to the movements including the process of move and motionless, the accelerator switch will send signals accordingly provided the strengths are up to the requirements so as to achieve a process of rapid changes in moving speed, that corresponds to pressing the corresponding buttons of the electronic game player. These signals are transmitted to the circuit board via the manner of radio, cable, infrared ray, supersonic and the likes so as to move the characters in the video game accordingly.

This manner of playing the game keeps the player staying in move state such that the eyes will not be susceptible to fatigue, furthermore, which is helpful to keep fit and physical train, meanwhile, improve the playing interest as well.

### BRIEF DESCRIPTION OF THE DRAWINGS

The present invention will become more obvious from the following description when taken in connection with the accompanying drawings, which shows, for purpose of illustrations only, the preferred embodiment in accordance with the present invention.

FIG. 1 is a schematic diagram of showing the electrical principle of an electronic game device in accordance with the present invention;

FIG. 2 is another schematic diagram of showing the electrical principle of the electronic game device in accordance with the present invention.

### DETAILED DESCRIPTION OF THE PREFERRED EMBODIMENT

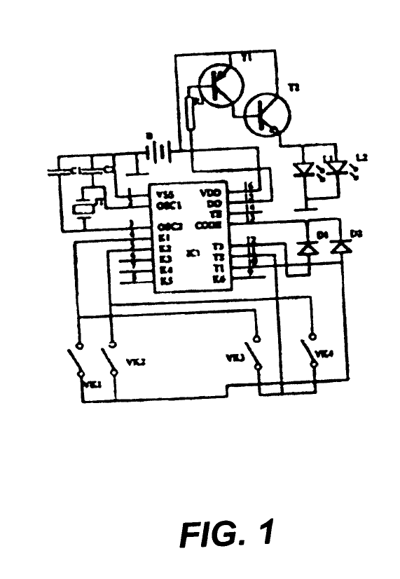

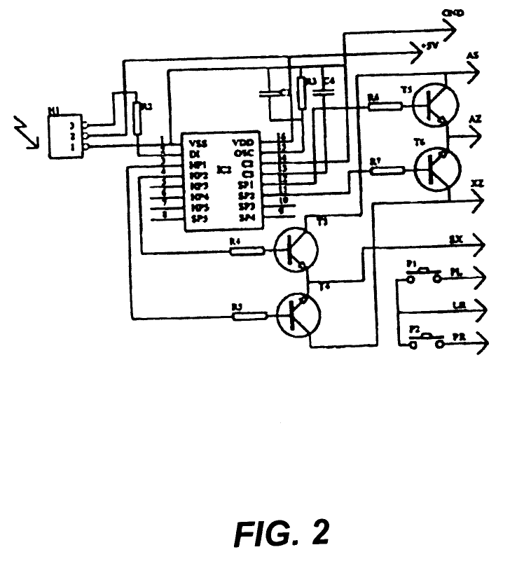

Referring FIGS. 1-2, which shows the electric principle diagram of an embodiment of the present invention that is applied to controlling the computer game. In which, the letter “B” represents a power source of 3V, T1 is a 2SC9015 triode, T2-T6 all are a 2SC9014 triode, R1-R7 each is a resistance of ⅛W, R3 is 39K□ and the rests are 10K□ for each, JT is a crystal of 455 HZ, C1, C2 are capacitor of 30PF, and C3, C4 are capacitor of 1000PF, L1, L2 is a TLN105 infrared ray tube respectively, D1, D2 is a IN41848 diode respectively, VK1-VK4 each is an accelerating switch, IC1 is a SZ9148 integrated circuit of infra code, H1 is an integral infrared receiving and magnifying integrated circuit of HS0038, IC2 is a decoding integrated circuit SZ9149 coordinating to that SZ9148. P1, P2 is a thin-film foot-switch. The linkage relations are: C1, C2 linked with the foot 2, 3 of the IC1 respectively and another end of which connected to the negative pole of the power. JT also links with the feet 2, 3, while the positive pole of the power connected to the foot 16 of the IC1, the emitter of T1, the collecting electrode of T2 respectively. The collecting electrode of T1 is connected to the base electrode of T2, the emitter of T2 is connected to the positive poles of L1, L2 respectively. The negative poles of L1, L2 are connected to the negative pole of the power source, while the base electrode of T1 is connected to the foot 15 of IC1 via R1. A first end of the VK1, VK3 is connected to the foot 4 of IC1 and a first end of the VK2, VK4 is connected to the foot 5 of IC1, while a second end of VK1, VK2 is connected to the foot 10 of IC1 as well as the positive pole of D2 respectively, and a second end of VK3, VK4 is connected to the foot 11 of IC1. The foot 12 of IC1 connects with the positive pole of D1 while the foot 13 of IC1 connects with the negative poles of D1, D2 respectively. The foot 3 of H1 is connected to the foot 2 of IC2 via R2, the foot 2 of H1 is connected to the foot 16 of IC2 then together connected to a power source of +5V. The foot 1 of H1 is connected to the foot 1, 14 of IC2, a first end of the C3, R3, C4 and GND respectively, while a second end of the C3, R3 are connected to the foot 15 of IC2 and a second end of C4 connected to the foot 13 of IC2. The foot 3, 4, 12, 11 of IC2 are connected to the base electrode of T3, T4, T5, T6 respectively via R4, R5, R6, R7. The emitter of T3, T4 connects with SX and that of T5, T6 connects with AZ, while the collecting electrodes of T3, T5 connect with AS and that of T4, T6 connect with XZ. A first end of P1, P2 connects with LR and second end of the same connects with PL, PR respectively. Here GND, +5V, AS, AZ, XZ, SX, PL, LR, PR all are not elements and parts but numbers of the lines, which can be connected to the corresponding feet in the keyboard directly so as to control the wrestle video game, or can be connected to the corresponding feet of the microchip directly to integrate together so as to control the game as a substitute for the keyboard. The connecting manner is: GND□+5V mean connecting with the GND□+5V of the line of the keyboard, AS means connecting with the communal lines of the keys “A” “S”, and AZ, XZ, SX can be inferred on the analogy of this, LR means connecting with the communal line of the keys “move left” “move right”, and another feet of these two keys are connected to PL, PR respectively.

The feature of structure and working principles of the embodiment of the present invention are: IC1 and the neighboring elements constitute the infrared encoding circuit, while IC2 together the neighboring elements constitute the infrared receiving, decoding, output circuit. The detailed working principles of IC1□IC2 can be consulted the “Elctronic World” of 1998-7, page 31, publication number of which is CNH-2086/TN. Here, it will be noted that the circuit consisting of the IC1 and the likes worn by the player, such as in the hands, feet. Also which can be made in two sets, the circuits are similar to each other, only difference is: the first set is connected to VK1, VK2 only and the second set is connected to VK3, VK4 only. One set is for wearing on one hand and the other for wearing on another hand or feet. L1 and L2 are positioned with different direction so as to reducing the dead angles of emitting. VK1-VK4 can be the final products of the accelerating switch or can be made by the producers themselves. Such as taking advantage of a stationary copper plate and a spring, the spring has a first end connected to lines and a second end fixed with a metal ball. The movement of player effects the oscillation of the ball and will enable it to contact the cooper plate, such that to send out the signals of switching on and off, these signals are processed by IC1 and magnified by the composite tube consisted by T1, T2 and then sent out by L1, L2 in an infrared ray manner. After H1 receives them, IC2 will further process the signals and output corresponding signals so as to communicate with one of the T3-T6, that corresponds to pressing down a certain key. In case that this key is set for waving fists, thus the player can wear the corresponding accelerating switch on the wrist with the direction well adjusted, and then is able to simulate the real wrestle. In this preferred embodiment, the conduction station of T3-T6 corresponds to pressing down the keys S, X, A, Z respectively, P1, P2 are thin-film foot switch or micro-hand handle switch for the left and right movement of the characters in the game, which corresponds to the “left move” “right move” key on the keyboard. The circuit board consisted by IC2 and the neighboring elements can be disposed in a plastic housing independently. A lead-in of the out-protruding receiving surface with respect to H1 can enter in the keyboard of the computer so as to be applied to the reequipping of ordinary keyboard, or alternatively connect with the control integrated circuit directly and then disposed in a plastic housing with the lead-in connected to the jack of the keyboard directly. Then the player can stand in front of the computer with the emitting device on to simulate the real wrestle, plays games while keeping fit.

While we have shown and described the embodiment in accordance with the present invention, it should be clear to those skilled in the art that further embodiments may be made without departing from the scope of the present invention.

What is claimed is:

1. An electronic game device for simulating real wrestle comprising: a circuit board being disposed in a housing, the housing can be the housing of an video game player or computer, on the circuit board an input terminal of power source, a signal input terminal, a signal output terminal being disposed respectively, and further comprising a signal input device which can be worn by the player for radio or cable transmitting signals to the signal input terminal, which characterized that the signal input device consisting of a plurality of accelerating switches.
